(19) United States
(12) Patent Application Publication
(10) Pub. No.: US 2015/0112862 A1
(43) Pub. Date: Apr. 23, 2015

(54) PEER-TO-PEER PAYMENT REGISTRATION AND ACTIVATION

(71) Applicants: Shaygan Kheradpir, London (GB); Darren Foulds, Hampshire (GB); Ian Sayers, Cheshire (GB); Sean Gilchrist, Surrey (GB); Philip Sowter, Essex (GB); Andrew Whaley, Buxton (GB); George French, Bedford (GB); Jeremy Goldstone, Manchester (GB); Simon Bartlett, Wigan (GB); Jenny Murray, Stockport (GB); Trish Stockton, Shropshire (GB); Suzanne Young, Cheshire (GB)

(72) Inventors: Shaygan Kheradpir, London (GB); Darren Foulds, Hampshire (GB); Ian Sayers, Cheshire (GB); Sean Gilchrist, Surrey (GB); Philip Sowter, Essex (GB); Andrew Whaley, Buxton (GB); George French, Bedford (GB); Jeremy Goldstone, Manchester (GB); Simon Bartlett, Wigan (GB); Jenny Murray, Stockport (GB); Trish Stockton, Shropshire (GB); Suzanne Young, Cheshire (GB)

(73) Assignee: BARCLAYS BANK PLC, London (GB)

(21) Appl. No.: 14/360,454

(22) PCT Filed: Nov. 30, 2011
(86) PCT No.: PCT/GB2011/052367

§ 371 Date: Jan. 7, 2015

(30) Foreign Application Priority Data
Nov. 23, 2011 (GB) 1120218.1

(51) Int. Cl. G06Q 20/22; G06Q 20/38; H04L 29/06

(52) U.S. Cl. CPC G06Q 20/223; H04L 63/08; H04L 63/0281; G06Q 20/385
USPC 705/44

(57) ABSTRACT

A user is registered for an electronic peer-to-peer payment system by authenticating the user at an automated teller machine (ATM), receiving the user's mobile number and addressing a verification code to the user's mobile number, which the user must enter in order to be registered.

### FIELD OF THE INVENTION

This invention relates to a peer-to-peer (P2P) payment method and system, and particularly but not exclusively to secure user registration and to secure activation of a mobile P2P payment application.

### BACKGROUND OF THE INVENTION

A P2P payment may be defined as a money payment between remote sender and recipient parties, as distinct from a point of sale (POS) transaction where the sender of the payment is a merchant and the account to which the payment is made is defined by a POS transaction system. P2P payments generally involve a greater risk in ensuring that the payment reaches the intended recipient.

The most conventional mode of P2P payment is by cash or cheque (check in US English), but the former is unsuitable for remote payments and the latter is prone to fraud and is inconvenient for both sender and recipient. Another alternative is direct bank-to-bank transfer, but this requires the recipient to disclose his or her bank account details to the sender, which presents a security risk.

Electronic P2P payment systems have been developed, in which the sender identifies the recipient by a unique proxy identifier (ID) such as an email address, mobile number or social networking ID. The recipient associates his or her receiving bank account with the proxy ID and is therefore able to receive the P2P payment. Alternatively, where the recipient does not have a bank account or wishes to receive the payment in cash, some method is necessary to authenticate and authorize the recipient. Examples of current electronic P2P systems include the PopMoney™ system from CashEdge Inc. and the QuickPay™ system from JP Morgan Chase.

Known electronic P2P payment systems may allow the sender to initiate a payment by means of a mobile device, such as a smartphone; this is convenient for users not only because of the general convenience and availability of smartphones, but also because these already store contact details such as mobile numbers which may be used as unique identifiers of P2P recipients.

One problem with using a mobile device ID as the proxy ID is the binding between the identity of the mobile device and the intended recipient. The mobile device may be stolen and possibly associated with another bank account than that of the intended recipient. It would be desirable to provide a system and method for secure registration of users in an electronic P2P payment system, particularly but not exclusively involving mobile devices.

Another problem is the secure activation of P2P payment applications for initiating payments on mobile devices.

### SUMMARY OF THE INVENTION

According to one aspect of the present invention, there is provided a method and system for registration of a user for P2P payments, wherein the association between the user's proxy ID and bank account is performed by means of an authentication token, such as a bank card, at an authentication terminal such as an automated teller machine (ATM). The proxy ID may be associated with a mobile device. The registration system may be enabled by an application on the mobile device.

In one embodiment, the process of registration relies on the inherent security provided by the ATM, to take the mobile phone number and account details of a user registering for the P2P payment service. The user wishing to register for the service may insert their bank card into the ATM and select an option to register for the P2P payment service. The user is given a choice either to register to send and receive payments or to register for receiving only. The user opting to register for receive only is prompted to enter the mobile number to which the service will then send a mobile activation code via short message service (SMS). The user inputs the mobile activation code on the ATM to establish the relationship between the mobile number and the receiving bank account. Once this process is completed, the user is registered to receive payments using the mobile number as a proxy ID. Any subscriber to the P2P payment service can then send money to this registered user by providing just the mobile phone number as proxy ID and the P2P payment service uses this proxy ID to identify the correct bank account in which to deposit the money.

According to another aspect of the invention, there is provided a method and system for registration and/or activation of a P2P payment application on a mobile device, wherein the registration is commenced within the application and completed on a payment token authentication terminal, such as an ATM.

In one embodiment, a mobile application is loaded on a user's mobile device, which application enables the user to both send and receive payments from their mobile device, using the recipient's mobile phone number as a proxy ID for the recipient's account. The user provides their bank account sort code and account number to the application, together with their mobile phone number (or the latter is obtained by the application from the mobile device itself, where this is permitted by the application platform). The user then receives a mobile verification code by SMS on the mobile device. To complete the registration, the user must prove that they have access to the account; they can either do this by providing existing internet banking credentials, for example by means of a card reader terminal such as Barclays® PINSentry®, or by completing the registration at an ATM.

If the user elects to use the ATM, then the mobile application generates a one-time passcode. The user then inserts their card into the ATM and uses the existing chip and PIN authorisation service which the ATM provides to verify that they are the owner of the card and therefore of the account. The customer then selects at the ATM the option to register for the P2P payment service. The ATM then prompts the user to enter the one-time passcode. The user inputs the one-time passcode on the ATM to establish the relationship between the mobile number and the bank account. Once this process is completed, the user's mobile application is registered to send and receive payments using the mobile number as proxy ID. Any subscriber to the P2P payment service can then send money to this user by providing just the user's mobile phone number as proxy ID, and the P2P payment service uses this proxy ID to identify the correct account in which to deposit the money. The customer can also initiate payments from their mobile application by entering the recipient's mobile number, or by using a contact list of names and phone numbers stored on the mobile device. The payments will be taken from the sender account which has been registered as part of this process.

According to yet another aspect of the present invention, there is provided a method and system for starting a registration/activation process of a secure mobile P2P payment application at an ATM and completing the process in the mobile application.

In one specific embodiment, the user inserts their card into the ATM and selects an option to register for the P2P payment service. The user is given a choice either to register to make and receive payments or to register for receiving only. The customer selects the option to send and receive payments and is prompted to enter a mobile number to which a mobile activation code is then sent as an SMS message. Since the user has used a secure ATM channel to generate the mobile activation code then the mobile application can be securely registered and activated.

In yet a further aspect of the present invention there is provided a mobile device, a mobile gateway, an ATM and associated computer programs arranged to carry out the above method.

### BRIEF DESCRIPTION OF THE DRAWINGS

There now follows, by way of example only, a detailed description of embodiments of the present invention, with references to the figures identified below.

FIG. 1 is a block diagram showing the main components of a mobile P2P payment registration system according to an embodiment of the invention;

FIG. 2 is a flow diagram of a P2P receive-only user registration process in a first embodiment of the invention.

FIG. 3 is a flow diagram of a mobile P2P application registration/activation process in a second embodiment of the invention.

FIG. 4 is a flow diagram of a mobile P2P application registration/activation process in a second embodiment of the invention.

FIG. 5 is a flow diagram of an example of a mobile P2P payment process.

FIG. 6 is a diagram of an example of a computer system on which one or more of the functions of the embodiment may be implemented.

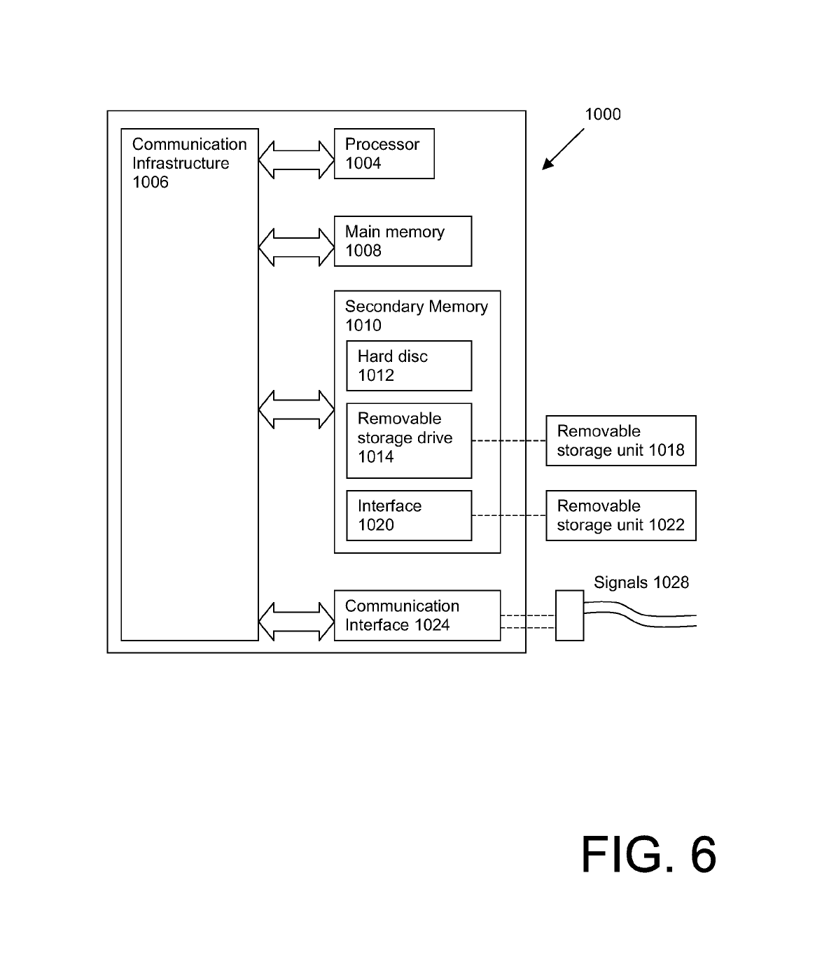

### DETAILED DESCRIPTION OF EMBODIMENTS OF THE INVENTION

### Technical Architecture

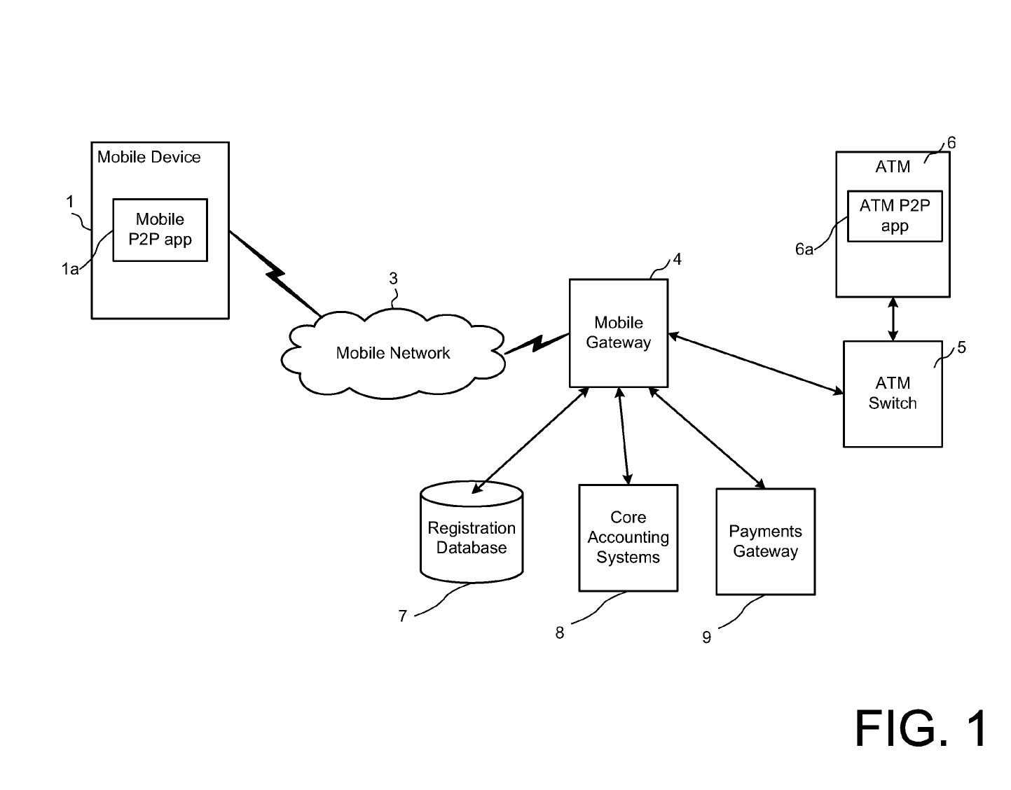

Referring to FIG. 1, a mobile P2P payment registration system according to an embodiment of the invention comprises a mobile device 1 communicating over a mobile network 3 with a mobile gateway 4. In some embodiments, the mobile device may run a novel mobile P2P payment application 1a. The mobile device 1 is of a type that is known per se, such as an iPhone™, Blackberry™ or Android™ smartphone. The mobile device need not have a voice telephony function. It will be appreciated that the mobile device 1 is merely an example of a potentially large number of mobile devices operable within the system.

The mobile gateway 4 interfaces with an ATM switch 5 for communication with an ATM 6 running a novel ATM P2P application 6a, using for example the BASE24 protocol. The ATM switch 5 and the ATM 6 are of a type that is known per se in ATM networks and need not be described further.

The mobile gateway 4 also manages a registration database 7 to record the mapping of proxy IDs, such as mobile numbers, email addresses or social network identities, to mobile devices 1. The registration database 7 may store details of the mobile devices 1, such as IMEI numbers. The mobile gateway 4 also records receive-only registrations from the ATM 6.

The mobile gateway 4 communicates with the mobile P2P payment application 1a using a data interchange protocol such as JSON (JavaScript Object Notation) over a wireless data connection such as GPRS, EDGE or 3G. The mobile gateway 4 is also able to send short messages to the mobile device 1 using for example SMS.

The functionalities of the mobile gateway 4 and of the registration database 7, particularly the integration of the ATM platform as a trusted authentication mechanism into the mobile application registration and activation process, are believed to be novel and inventive.

The mobile gateway 4 also communicates with core accounting systems 8 and a payments gateway 9, for implementation of the sending of payments from sender to recipient accounts. The core accounting systems 8 and payments gateway 9 are of a type that is known per se, and need not be described further.

### First Embodiment

A first embodiment of the invention enables a user to register at an ATM to receive P2P payments, using a mobile number as proxy ID. This embodiment relies on the inherent security of the ATM network to securely associate the recipient's bank account, as identified by the user's bank card at the ATM, with the mobile number.

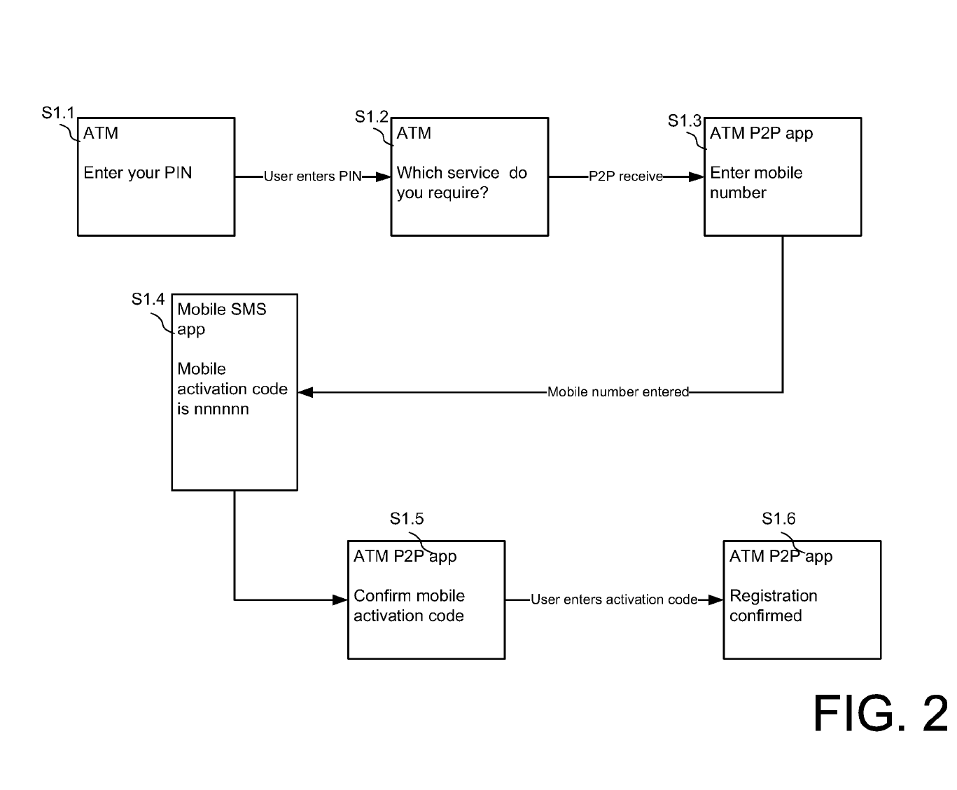

FIG. 2 shows a flow diagram of the user registration process, showing the user interface at the ATM 6 and the mobile device 1. At step S1.1, the user inserts their bank card into the ATM 6 and is prompted to enter their PIN. If the PIN if authenticated against the bank card, the ATM 6 prompts the user to select a service at step 1.2. If the user selects ‘P2P Receive’ as a service, the ATM 6 prompts the user to enter their mobile number at step S1.3. The ATM 6 then sends the mobile number together with account details identified from the user's bank card to the mobile gateway 4. The mobile gateway 4 then generates and stores a mobile activation code, which it sends to the user's mobile device 1, such that the activation code is displayed at step S1.4. The user is then prompted by the ATM 6 to enter the mobile activation code at step S1.5.

The user enters the mobile activation code at the ATM 6 and the entered mobile activation code is then compared with the mobile activation code generated by the mobile gateway 4; this comparison may be done at the ATM 6 by receiving the generated mobile activation code from the mobile gateway 4, or at the mobile gateway 4 by receiving the entered mobile activation code from the ATM 6. If the entered mobile activation code matches the generated mobile activation code, then the ATM 6 confirms to the user at step S1.6 that the registration process is successful. The user may then receive P2P payments using the mobile number as proxy ID, as in the P2P payment example below.

### Second Embodiment

A second embodiment of the invention enables a user to register and activate the mobile P2P application 1a to send and/or receive P2P payments, using the ATM 6 to verify that the user has access to their associated bank account and thereby complete the registration/activation process.

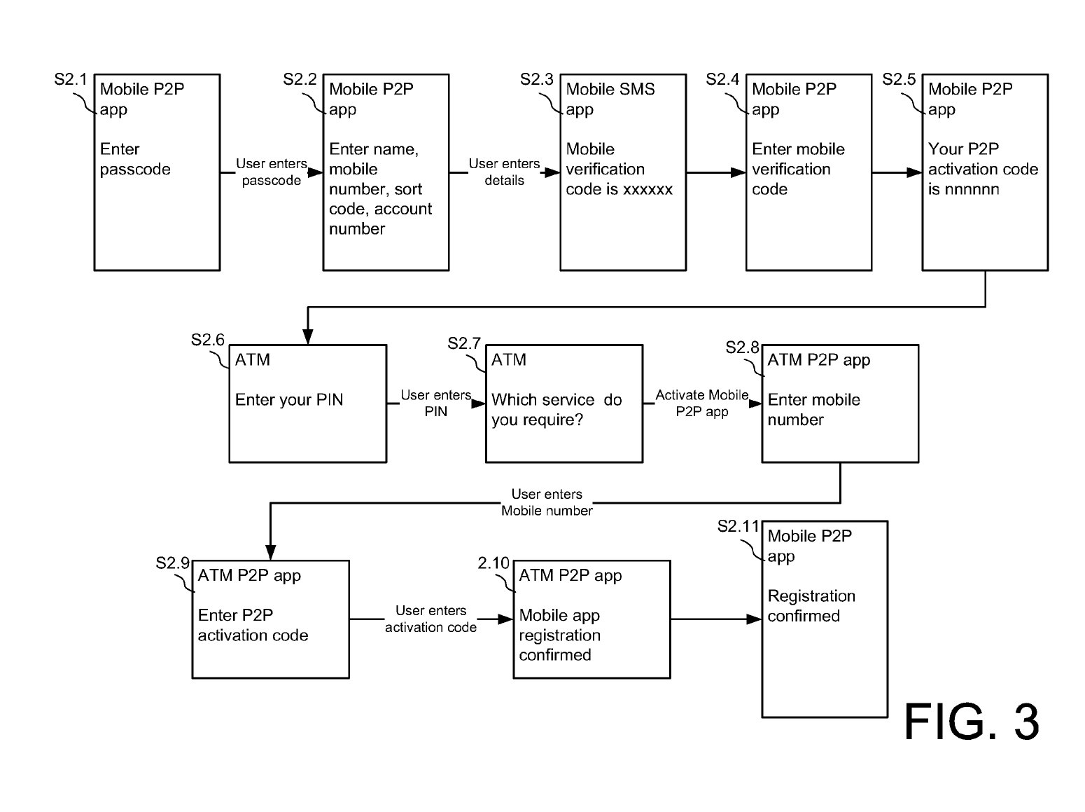

FIG. 3 shows a flow diagram of the user registration process, showing the user interface at the ATM 6 and the mobile device 1. At step S2.1, the user accesses the mobile P2P application 1a on their mobile device 1 by entering a passcode. If the passcode is correct, at step S2.2 the user is prompted to enter their mobile number (if this is not already known or obtainable by the application 1a) and their bank account details, such as the account name, sort code and account number. The user enters these details, which are then sent to the mobile gateway 4 for verification, for example against the core accounting systems 8. If the details are verified, then the mobile gateway generates a mobile verification code which is sent by SMS to the mobile device 1 and displayed by a mobile SMS application at step S2.3. The user then enters the mobile verification code in the mobile P2P application 1a, at step S2.4, which then sends the entered mobile verification code to the mobile gateway 4.

The mobile gateway 4 then compares the entered mobile verification code with that previous sent by SMS to the mobile device 1. If the two match, the mobile gateway 4 then sends a P2P activation code to the mobile P2P application 1a, for display at step S2.5. The mobile gateway 4 may perform session management, for example to verify that the mobile device 1 and/or mobile SMS application 1a that sent the details at step S2.2 was the same as that which sent the mobile verification code at step S2.4.

To complete the registration/activation process, the user then inserts into the ATM 6 a bank card for the account as identified at step S2.2. The ATM 6 prompts the user to enter the card PIN at step S2.6 and to select a service at step S2.7. If the user selects ‘Activate Mobile P2P app’, then the ATM P2P application 6a prompts the user to enter their mobile number at step S2.8, and the P2P activation code at step 2.9. The entered mobile number and P2P activation code are send by the ATM P2P application 6a to the mobile gateway 4, for verification against the mobile number and corresponding previously generated P2P activation code. If the verification is successful, the mobile gateway 4 registers the mobile number against the account details, and sends a verification message to the ATM P2P application 6a and to the mobile P2P application 1a, for display at steps 2.10 and 2.11 respectively; these last two steps are independent and need not be sequential.

In response to the verification message, the mobile P2P application 1a is activated to send P2P payments: for example, cryptographic binding of the mobile P2P application 1a to the user's account or identity may be completed.

### Third Embodiment

A third embodiment of the invention enables a user to register and activate the mobile P2P application 1a to send and receive P2P payments, using the ATM P2P application 6a to initiate the process, and completing the process via the mobile P2P application 1a. The use of the secure ATM network to generate a mobile activation code enables the mobile P2P application 1a to be securely registered and activated.

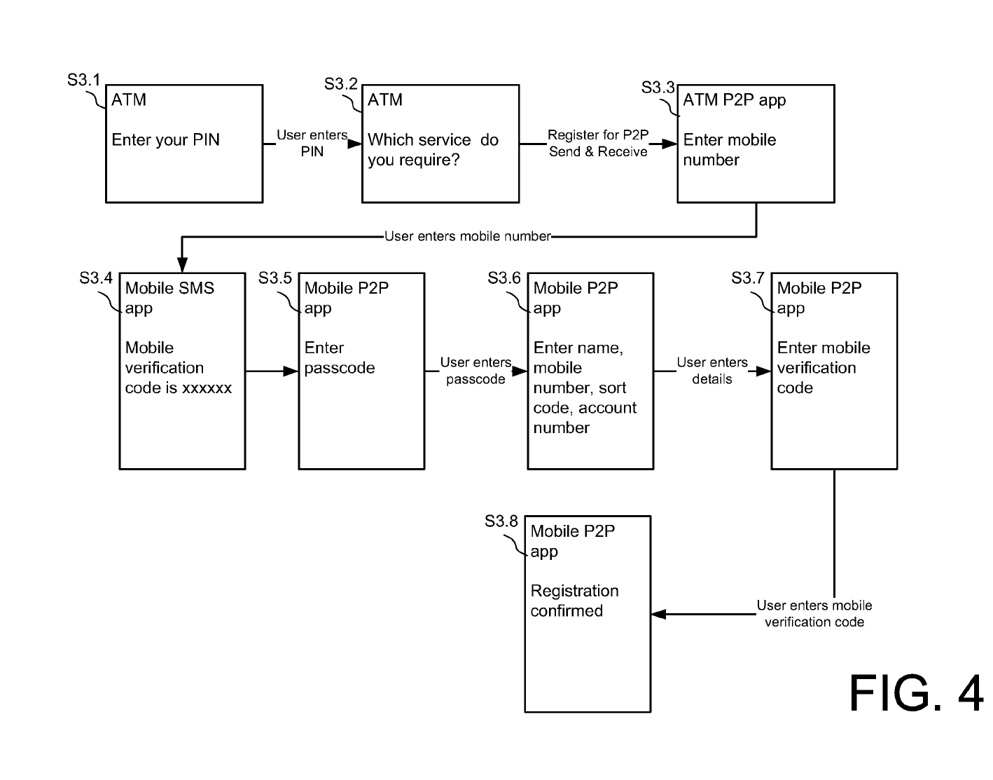

FIG. 4 shows a flow diagram of the user registration process, showing the user interface at the ATM 6 and the mobile device 1. The user inserts into the ATM 6 a bank card for an account that is to be associated with the mobile P2P application 1a. The user is prompted at step S3.1 to enter the PIN for that card, and if the PIN is correct, the user is prompted at step S3.2 to select the service required. The user selects the service ‘Register for P2P Send & Receive’, and the ATM P2P application 6a then prompts the user at step S3.3 to enter the mobile number of the mobile device 1 that is to be used for the P2P service. The entered mobile number is sent to the mobile gateway 4, which generates a mobile verification code and sends this via SMS to the entered mobile number. At step S3.4, the SMS message including the mobile verification code is displayed on the mobile device 1. The SMS message may also include a link for downloading the mobile P2P application 1a, if not already loaded on the mobile device 1.

At step S3.5, the user accesses the mobile P2P application 1a by entering a passcode. If the passcode is correct, at step 3.6 the user is prompted to enter their mobile number (if this is not already known or obtainable by the application 1a) and their bank account details, such as the account name, sort code and account number.

Once these are entered, the user is prompted to enter the mobile verification code, as previously received at step S3.4. The mobile P2P application then sends the bank account details and mobile verification code to the mobile gateway 4, for verification; if these details are verified, the mobile gateway 4 registers the mobile number against the account details, and sends a registration confirmation message to the mobile P2P application 1a for display to the user at step S3.8. In response to the verification message, the ATM P2P application 1a is activated to send P2P payments.

### P2P Payment Example

An example of P2P payments between users will now be described, to illustrate the technical advantage of the registration process embodiments described above.

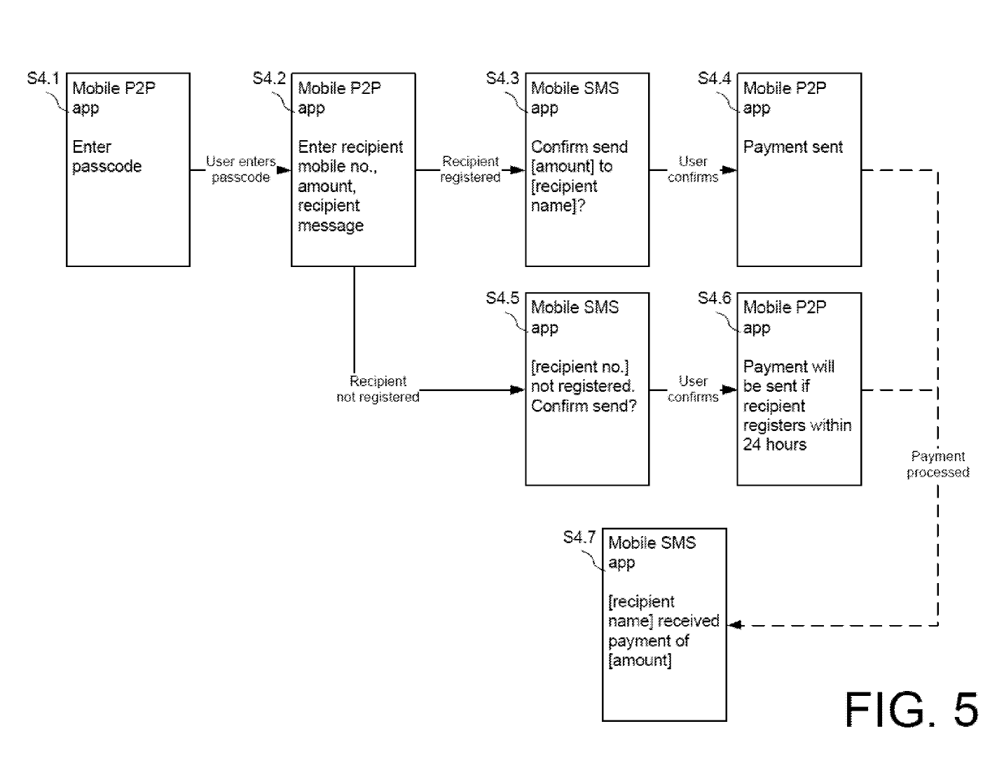

FIG. 5 shows a flow diagram of the user interface of the mobile device 1 of the sender of a P2P payment. At step S4.1, the user accesses the registered mobile P2P application 1a by entering a passcode. If the passcode is correct, at step S4.2 the user is prompted to enter the proxy ID (such as the mobile number) of the recipient, the amount of the payment, and a message to the recipient. Alternatively, if the mobile P2P application 1a is able to access a contact list stored on the mobile device 1, the sender may select the recipient from the contact list.

The mobile P2P application 1a then sends the proxy ID to the mobile gateway 4, which looks up the recipient proxy ID in the registration database 7 to determine whether the recipient is registered to receive P2P payments, and sends a registration indication message to the mobile P2P application 1a, including the recipient's name if registered.

If the recipient is registered, the mobile P2P application 1a displays a message at step S4.3 asking the user to confirm the P2P payment, and quoting the recipient's name as an indication that the recipient is registered. If the user confirms the P2P payment, the mobile P2P application sends a payment instruction message to the mobile gateway 4 and displays a confirmation message to the user at step S4.4.

If the recipient is not registered, the mobile P2P application 1a displays a message at step S4.5 indicating that the recipient proxy ID is not registered and asking the user to confirm the payment. If the user confirms the P2P payment, the mobile P2P application sends a payment instruction message to the mobile gateway 4, including the entered recipient proxy ID, and displays a confirmation message to the user at step S4.6.

In either case, the payment instruction message is digitally signed by the mobile P2P application 1a, using a key or code. This key or code may be generated when the P2P payment application 1a is activated, and access to the key or code is secured using the passcode required to access the mobile P2P application 1a.

In either case, if the payment is successfully made to recipient's account, the mobile gateway 4 sends a payment confirmation SMS to the mobile device 1, including the name of the recipient, which is displayed to the user at step S4.7. Where the payment is confirmed but cannot be made until a future date, such as the following day, the future payment date may be included in the payment confirmation message.

If the recipient is registered to receive P2P payments, the mobile gateway 4 processes the payment to the recipient using the bank account details registered against the recipient's proxy ID in the registration database, and sends a payment SMS message to the recipient indicating the amount paid, the name of the sender, and the message entered at step S4.2. Where the payment is confirmed but cannot be made until a future date, such as the following day, the future payment date may be included in the payment SMS message.

If the recipient is not registered to receive P2P payments, the mobile gateway 4 sends an SMS message to the recipient indicating that the sender has initiated a P2P payment to the recipient, and requesting that the recipient register with the P2P system within a predetermined time, such as 24 hours. The recipient may then register by means of any of the embodiments described above; provided that the recipient registers using the proxy ID used by the sender to initiate the payment, within the predetermined time, the mobile gateway 4 will then process the payment.

### Computer Systems

The entities described herein, such as the mobile gateway, may be implemented by computer systems such as computer system 1000 as shown in FIG. 10. Embodiments of the present invention may be implemented as programmable code for execution by such computer systems 1000. After reading this description, it will become apparent to a person skilled in the art how to implement the invention using other computer systems and/or computer architectures.

Computer system 1000 includes one or more processors, such as processor 1004. Processor 1004 may be any type of processor, including but not limited to a special purpose or a general-purpose digital signal processor. Processor 1004 is connected to a communication infrastructure 1006 (for example, a bus or network). Various software implementations are described in terms of this exemplary computer system. After reading this description, it will become apparent to a person skilled in the art how to implement the invention using other computer systems and/or computer architectures.

Computer system 1000 also includes a main memory 1008, preferably random access memory (RAM), and may also include a secondary memory 610. Secondary memory 1010 may include, for example, a hard disk drive 1012 and/or a removable storage drive 1014, representing a floppy disk drive, a magnetic tape drive, an optical disk drive, etc. Removable storage drive 1014 reads from and/or writes to a removable storage unit 1018 in a well-known manner. Removable storage unit 1018 represents a floppy disk, magnetic tape, optical disk, etc., which is read by and written to by removable storage drive 1014. As will be appreciated, removable storage unit 618 includes a computer usable storage medium having stored therein computer software and/or data.

In alternative implementations, secondary memory 1010 may include other similar means for allowing computer programs or other instructions to be loaded into computer system 1000. Such means may include, for example, a removable storage unit 1022 and an interface 1020. Examples of such means may include a program cartridge and cartridge interface (such as that previously found in video game devices), a removable memory chip (such as an EPROM, or PROM, or flash memory) and associated socket, and other removable storage units 1022 and interfaces 1020 which allow software and data to be transferred from removable storage unit 1022 to computer system 1000. Alternatively, the program may be executed and/or the data accessed from the removable storage unit 1022, using the processor 1004 of the computer system 1000.

Computer system 1000 may also include a communication interface 1024. Communication interface 1024 allows software and data to be transferred between computer system 1000 and external devices. Examples of communication interface 1024 may include a modem, a network interface (such as an Ethernet card), a communication port, a Personal Computer Memory Card International Association (PCMCIA) slot and card, etc. Software and data transferred via communication interface 1024 are in the form of signals 1028, which may be electronic, electromagnetic, optical, or other signals capable of being received by communication interface 1024. These signals 1028 are provided to communication interface 1024 via a communication path 1026. Communication path 1026 carries signals 1028 and may be implemented using wire or cable, fibre optics, a phone line, a wireless link, a cellular phone link, a radio frequency link, or any other suitable communication channel. For instance, communication path 1026 may be implemented using a combination of channels.

The terms “computer program medium” and “computer usable medium” are used generally to refer to media such as removable storage drive 1014, a hard disk installed in hard disk drive 1012, and signals 1028. These computer program products are means for providing software to computer system 1000. However, these terms may also include signals (such as electrical, optical or electromagnetic signals) that embody the computer program disclosed herein.

Computer programs (also called computer control logic) are stored in main memory 1008 and/or secondary memory 1010. Computer programs may also be received via communication interface 1024. Such computer programs, when executed, enable computer system 1000 to implement embodiments of the present invention as discussed herein. Accordingly, such computer programs represent controllers of computer system 1000. Where the embodiment is implemented using software, the software may be stored in a computer program product and loaded into computer system 1000 using removable storage drive 1014, hard disk drive 1012, or communication interface 1024, to provide some examples.

Alternative embodiments may be implemented as control logic in hardware, firmware, or software or any combination thereof.

### Alternative Embodiments

The above embodiments are described by way of example, and alternative embodiments which may become apparent to the skilled person on reading the above description may nevertheless fall within the scope of the claims.

Instead of inserting a bank card into the ATM, the user may present an authentication token to the ATM for reading in an alternative way, such as swiping a contactless card or a mobile wallet using near-field communication (NFC).

As an alternative to using an ATM for user ID&V, the user may user a PIN servicing terminal connected to the mobile gateway via the Internet. However, this may be less secure than the ATM network.

The use of a mobile number as a proxy ID is advantageous, as it allows the verification or activation codes to be pushed to the mobile via a different communication channel than that used by the mobile P2P payment application. However, an alternative proxy ID such as an email address or social networking identity may be used to identify a recipient of a P2P payment. In this case, the alternative proxy ID may be associated with the mobile number during the registration process.

1. A method of activating an electronic peer-to-peer payment application on a mobile device of a user, the method comprising the steps of:
i. authenticating a user by an authentication token presented by the user and read at an authentication terminal;
ii. identifying, from the authentication token, a user account associated with the user;
iii. receiving a proxy identifier from the user;
iv. addressing a verification code to the user by the proxy identifier;
v. receiving a code entered by the user into the electronic peer-to-peer payment application at a mobile device associated with the proxy identifier;
vi. verifying the code entered against the verification code; and, if the code entered is verified,
vii. registering the proxy identifier against the user account to enable payments to the user account in an electronic peer-to-peer payment system;
whereby the electronic peer-to-peer payment application is activated for use in the electronic peer-to-peer payment system.

2. The method of claim 0, wherein the proxy identifier is entered by the user at the authentication terminal.

3. The method of claim 1, wherein the user identifies the user account to the electronic peer-to-peer payment application at the mobile device, and registering the proxy identifier includes registering the user account against the proxy identifier.

4. A method of activating an electronic peer-to-peer payment application on a mobile device of a user, the method comprising the steps of:
i. receiving, from the electronic peer-to-peer payment application on the mobile device of the user, a proxy identifier associated with the mobile device of the user;
ii. addressing a verification code to the mobile device of the user by the proxy identifier;
iii. verifying a code entered by the user into the electronic peer-to-peer payment application on the mobile device of the user against the verification code,
iv. authenticating the user by an authentication token presented by the user and read at an authentication terminal, the authentication token identifying a user account; and, if the verifying and authenticating are successful,
v. registering the proxy identifier against the user account to enable payments to the user account in an electronic peer-to-peer payment system;
vi. activating the electronic peer-to-peer payment application for use in the electronic peer-to-peer payment system.

5. The method of claim 4, wherein the proxy identifier is entered by the user in the electronic peer-to-peer payment application.

6. The method of claim 5, wherein the proxy identifier is entered by the user at the authentication terminal after the authentication step.

7. The method of claim 4, further including sending an activation code to the user via the electronic peer-to-peer payment application and receiving the activation code from the user at the authentication terminal, wherein the electronic peer-to-peer payment application is activated if the activation code is verified.

8. The method of claim 4, including receiving an account identification in the electronic peer-to-peer payment application, the account identification identifying the user account to be associated with the proxy identifier in the electronic peer-to-peer payment system.

9. The method of claim 4, wherein access to the electronic peer-to-peer payment application is secured by a passcode.

10. The method of claim 4, wherein the proxy identifier comprises a mobile number.

11. The method of claim 4, wherein the authentication terminal comprises an automated teller machine.

12. The method of claim 4, wherein the authentication terminal comprises a card reader terminal.

13. The method of claim 4, wherein authenticating the user at the authentication terminal includes receiving from the user a PIN associated with the authentication token.

14. The method of claim 4, wherein the authentication token comprises a bank card.

15. The method of claim 4, wherein the authentication token comprises a contactless card or a mobile wallet.

16. A system comprising the steps of:
i. receiving, from an electronic peer-to-peer payment application on a mobile device of a user, a proxy identifier associated with the mobile device;
ii. addressing a verification code to the mobile device by the proxy identifier;
iii. verifying a code entered by the user into the electronic peer to peer payment application on the mobile device against the verification code,
iv. authenticating the user by an authentication token presented by the user and read at an authentication terminal, the authentication token identifying a user account; and, if the verifying and authenticating are successful,
v. registering the proxy identifier against the user account to enable payments to the user account in an electronic peer-to-peer payment system;
vi. activating the electronic peer-to-peer payment application for use in the electronic peer-to-peer payment system.

17. (canceled)
